(19) United States
(12) Patent Application Publication
(10) Pub. No.: US 2020/0242976 A1
(43) Pub. Date: Jul. 30, 2020

(54) DISPLAY CARD AND METHOD OF PACKAGING

(71) Applicant: Texpak, Inc., Franklin Square, NY (US)

(72) Inventor: STEVEN KUNREUTHER, New York, NY (US)

(21) Appl. No.: 16/695,578

(22) Filed: Nov. 26, 2019

Related U.S. Application Data
(60) Provisional application No. 62/797,725, filed on Jan. 28, 2019.

(51) Int. Cl. G09F 1/04

(52) U.S. Cl. CPC G09F 1/04

(57) ABSTRACT

A display card with a surface is formed of a paper product. The card has spaced, oppositely oriented, integral die cut flap members each of which is positioned to be generally perpendicular to the card surface. One or more products are placed on the card, between the flap members. A fastener is then applied to the card, over the products, with the ends of the fastener anchored to the card, at either side of the products. In this manner, the products are securely mounted on the display card, eliminating the need for a blister package.

### BACKGROUND OF THE INVENTION

### 1. Field of the Invention

The present invention relates to display cards and to a method of packaging and displaying products, including products with cylindrical portions, on such display cards.

### 2. Description of Prior Art Including Information Disclosed Under 37 CFR 1.97 and 1.98

One of Avery Dennison's more successful products is the Elastic Staple or IndES which is often used to replace blister packaging when attaching products to cards. This is an environmentally sustainable packaging method as it eliminates a significant amount of plastic that is used in blister packaging. In addition, in many cases it is less costly for the manufacturer to use this method when compared to blister pack.

As can be seen from the Avery Dennison U.S. Pat. No. 6,536,648, the products are attached to the cards by staples applied by a machine which has two spaced parallel hollow needles, one of which is inserted into the card on either side of the product, and a flexible plastic filament with “T bars” on either end. The “T bars” travel through the needles and emerge on the other side of the card. In this operation, the filament mounts the product to card.

Many different shaped products are presently packaged on display cards using this method. The method works well with cylindrical products with wider and narrower portions (non-uniform diameters), such as paint brushes, screw drivers, ice cream scoops and the like. For those products, it is not possible for a consumer to simply remove the product from the card without breaking the staples, when the staples are applied to one of the narrower sections of the article.

However, at present it is virtually impossible to secure products with certain shapes to a display card with the Avery Dennison staples, including cylindrically shaped products with substantially uniform diameters such as pens and markers, products with a continuously decreasing width or products having a flat rectangular shape with the same width throughout. No matter how tight the staple is on the product, it can never be tight enough to prevent a consumer from sliding the product out from underneath the staples.

There is therefore a need for a display card, and for a method for displaying and packaging products including cylindrically shaped products with substantially uniform diameters, products with a continuously decreasing width or products with a flat rectangular shape with uniform width throughout on a display card, which has the advantages of the Avery Dennison staple, but which can be used to mount such products to a display card in a manner that prevents the removal of the product without breaking the fastener.

### BRIEF SUMMARY OF THE INVENTION

In its simplest form, the present invention is a display card with a surface, formed of a paper product. The card has spaced, oppositely oriented flap members situated in a position generally perpendicular to the card surface. One or more products are placed on the card, between the flap members. A fastener is then applied to the card, over the products, with the ends of the fastener anchored to the card, at either side of the products. The products cannot be removed from the card without breaking the fastener because the flap members prevent the products from being moved in either direction relative to the card body.

More specifically, in accordance with one aspect of the present invention, a display card is provided having a body with a substantially planar surface. A member extends from surface to a position substantially perpendicular to the body surface. An elongated fastener extends from the body surface and defines an opening with the body surface. The opening is aligned with and spaced from the member.

The member is preferably integral with the card body. The member may take the form of a flap die cut from card body.

The card body has an edge which extends along the width of the card body. The member and the elongated fastener each extend in a direction substantially parallel to the edge of the card body.

The fastener includes a flexible plastic filament. The filament has first and second ends. The filament ends penetrate the card surface in order to anchor the filament to the card body. Each end of the filament has an enlarged part which lodges behind the card body.

A second member, integral with the card body, may be provided extending from the card surface to a position substantially perpendicular to the card surface. The members are spaced apart such an article can be received therebetween. The second member preferably takes the form of a flap die cut from the card body.

In accordance with another aspect of the present invention, a card is provided for displaying a product having an end. The card includes a body having a substantially planar surface. A member extends from the card surface to a position substantially perpendicular to the card surface and proximate the end of the product. An elongated fastener extends from the card surface to maintain the product adjacent the card surface.

The article has a second end. The card includes a second member. The second member extends from the card surface to a position substantially perpendicular to the card surface. The second member is situated at a location spaced from first member, and proximate the second end of the article.

In accordance with another aspect of the present invention, a card is provided for displaying a product having a portion with a generally cylindrical shape having first and second ends. The card includes a body having a substantially planar surface. First and second spaced members, each extending from the card surface to a position substantially perpendicular to the card surface, are situated with the product extending therebetween. An elongated fastener extends from the card surface to maintain the product adjacent the card surface.

In accordance with another aspect of the present invention, a method is provided of securing a product with an end to a display card of the type having a body with a substantially planar surface. The method includes the following steps: forming a member in the body; rotating the member to a position substantially perpendicular to the body surface; placing the product adjacent the body surface with the end thereof proximate the member; and attaching an elongated fastener to the card body to maintain the product adjacent the body surface.

The product has a second end. The method further includes the steps of: forming a second member in the body at a location spaced from the first member; rotating the second member to a position substantially perpendicular to the body surface; and placing the product adjacent the body surface with the ends thereof between the first member and the second member.

### BRIEF DESCRIPTION OF THE SEVERAL VIEWS OF DRAWINGS

To these and to such other objects that may hereinafter appears, the present invention relates to a display card and a method of displaying and packaging an article on such a display card, as described in detail in the following specification and recited in the annexed claims, taken together with the accompanying drawings, in which like numerals refer to like parts and in which:

FIG. 1 is a perspective view of a first preferred embodiment of the display card with the flap members die cut;

FIG. 2 is a perspective view of the display card of FIG. 1 with each of the flap members rotated to a position perpendicular to the front surface of the display card;

FIG. 3 is a perspective view of two markers of the type which could be mounted on the display card of FIG. 2;

FIG. 4 is a perspective view of the markers of FIG. 3 mounted on the display card of FIG. 2 by two spaced filament fasteners, each fastener having “T-bar” ends;

FIG. 5 is a perspective view of back of the display card of FIG. 4 showing the “T-bar” ends of the fasteners lodged against the back surface of the card; and

FIG. 6 is a front elevation view of a second preferred embodiment of the present invention wherein a single flap member and a single filament fastener with “T-bar” ends are used to mount a product with a continuously decreasing width on the display card.

### DETAILED DESCRIPTION OF THE INVENTION

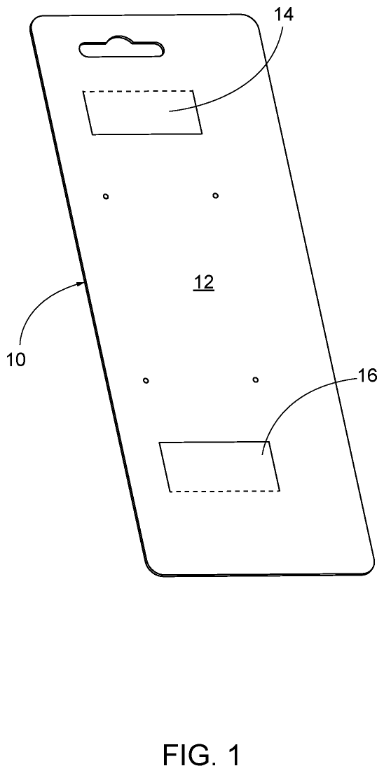

As seen in FIG. 1, the first preferred embodiment of the present invention includes a display card 10 formed of a paper product such as thin cardboard. It is preferable to select one of the many card stocks presently available that are difficult to bend more than 90 degrees. Such a paper stock makes it difficult to bend the card to a position where the product can be removed from the card.

The display card as illustrated has a generally rectangular shaped body with a substantially planar front surface 12. However, the display card can have any shape, as long as the card is large enough to accommodate the product which will be carried by the display card.

First and second spaced flap members 14, 16 are die cut in the card body in a manner which leaves bottom edge of each flap member attached to the card body, as indicated by the broken lines in the figure. In that way, each flap member remains integral with and connected to the card body and can be rotated or folded about an axis along the bottom of the flap member. The fold lines extend in a direction generally parallel each other and parallel to the top and bottom edges of the display card.

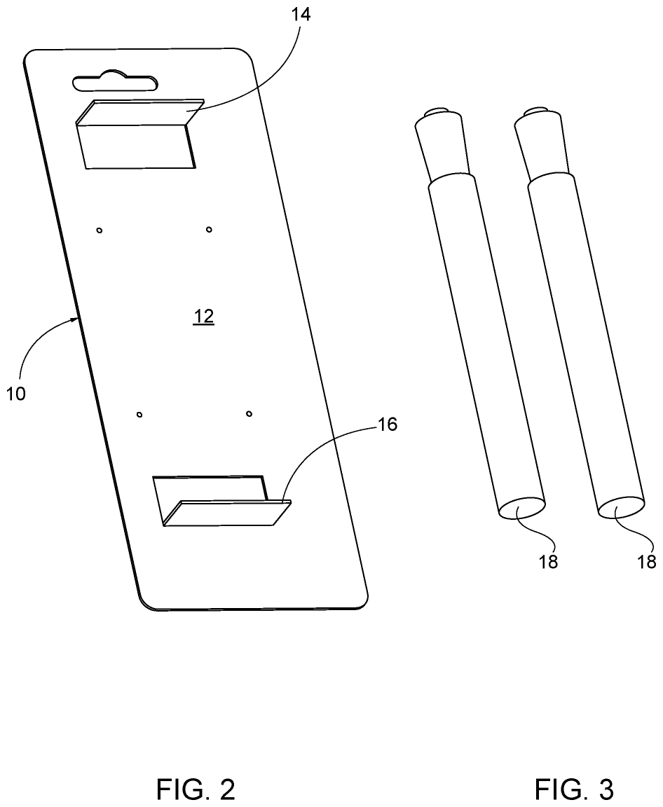

FIG. 2 shows the display card of FIG. 1 with flap members 14, 16 rotated to their respective product engagement positions, substantially perpendicular to the front surface 12 of the display card. In that position, the flap members provide additional resistance to bending the display card to remove the product.

FIG. 3 shows two cylindrically shaped markers 18 with substantially uniform diameters of the type which could be mounted on display card 10. Markers 18 would normally require a blister package to retain the markers. The blister package would be required to prevent the markers from sliding out from under the filament fasteners on a conventional display card.

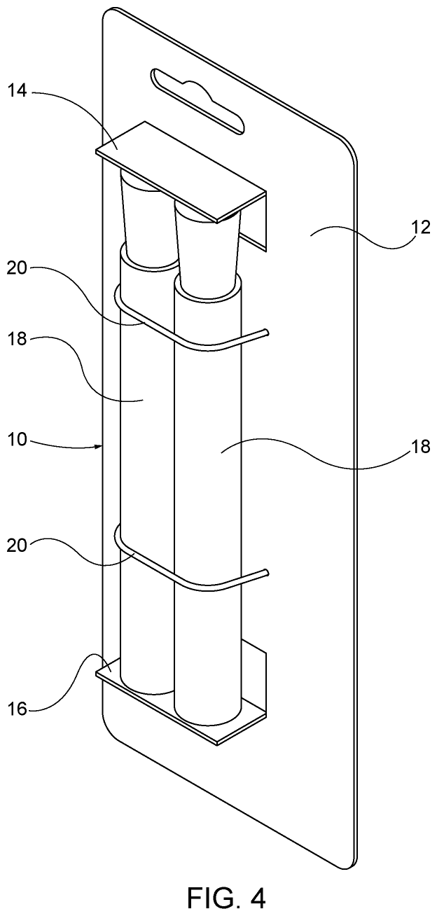

FIG. 4 shows flap members 14, 16 rotated or folded to their product engagement positions substantially perpendicular to the front surface 12 of the display card with the markers 18 in a side-by-side relation extending between flap members 14 and 16. FIG. 4 also shows two spaced flexible filament fasteners 20, each with enlarged “T-bar” ends 22 anchored on either side of the markers 18. The filaments of the fasteners extend in a direction generally parallel to each other, and parallel to the top and bottom edges of the display card.

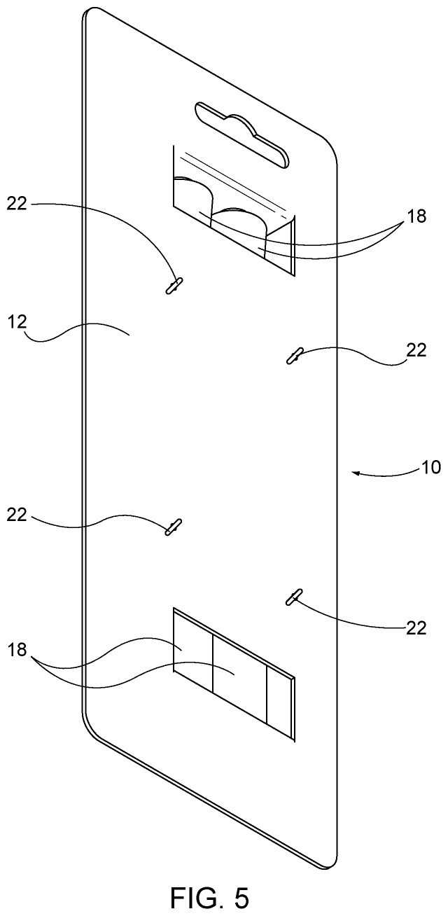

FIG. 5 shows the back of the display card 10 of FIG. 4, with the “T bar” ends 22 of each fastener 20 lodged against the back surface of the display card.

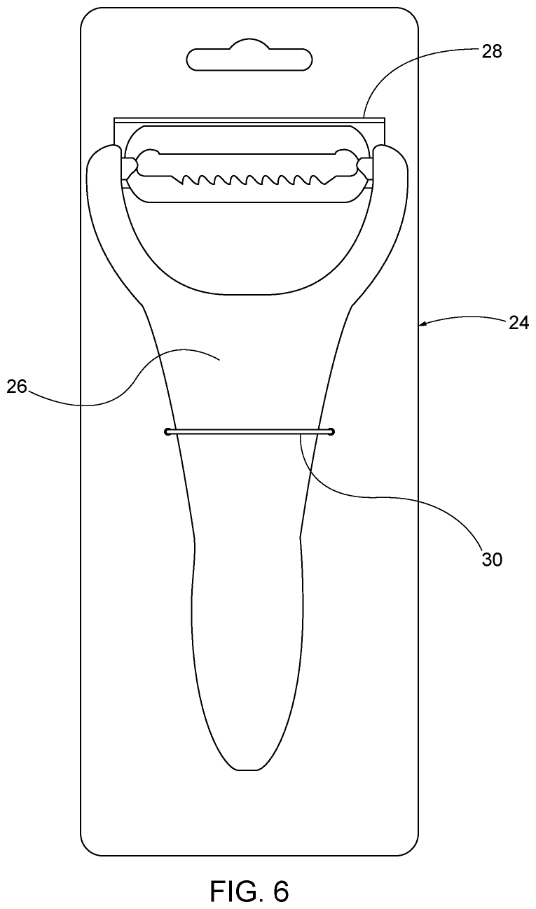

FIG. 6 illustrates a second preferred embodiment of the display card 24. This embodiment may be used to mount products with continuously decreasing widths to the card, for example a cheese grater 26. Because of the shape of the cheese grater, only a single flap member 28 and a single filament fastener 30 are required to securely mount the cheese grater to the card.

It will now be understood that an product can be securely mounted to the display card of the present invention having a planar surface, without the necessity of a blister package, by the following steps: forming at least one flap member in the card body; rotating the at least one flap member to a position substantially perpendicular to the body surface; placing the product adjacent the body surface with the end thereof proximate the flap member; placing an elongated filament fastener over the product and attaching the ends of the fastener to the card body.

For products which have cylindrical portions with a substantially uniform diameter, the method further includes the steps of: forming a second flap member in the card body at a location spaced from the first flap member; rotating the second flap member to a position substantially perpendicular to the body surface; placing the product adjacent the body surface with the ends thereof between the first flap member and the second flap member; and attaching the ends of a second elongated filament fastener to the card body at a location spaced from the first fastener.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims:

I claim:

1. A display card comprising a body, said body comprising a substantially planar surface, a member extending from said surface in a position substantially perpendicular to said body surface, and an elongated fastener extending from said body surface and defining an opening with said surface, said opening being aligned with and spaced from said member.

2. The card of claim 1 wherein said member is integral with said card body.

3. The card of claim 1 wherein said member comprises a flap cut from said card body.

4. The card of claim 1 wherein said card body has an edge and said member extends in a plane substantially parallel to said card body edge.

5. The card of claim 1 wherein said card body has an edge and said elongated fastener extends in a direction substantially parallel to said edge.

6. The card of claim 1 wherein said member and said fastener extend in planes substantially parallel to each other.

7. The card of claim 1 wherein said card body has an edge and each of said member and said fastener extend in a plane substantially parallel to said edge.

8. The card of claim 1 wherein said card body is generally rectangular.

9. The card of claim 1 wherein said card body has a width and wherein each of said member and said fastener extend in a direction along said width of said card body.

10. The card of claim 1 wherein said fastener comprises a filament.

11. The card of claim 10 wherein said filament comprises first and second ends, said filament ends being adapted to penetrate said card body surface to anchor said ends of said filament to said card body.

12. The card of claim 10 further comprising an enlarged part attached to each of said filament ends.

13. The card of claim 1 wherein said fastener comprises a flexible plastic filament with an enlarged part at each end.

14. The card of claim 1 further comprising a second member extending from said card body surface in a direction substantially perpendicular to said card body surface, said second member being spaced from said member.

15. The card of claim 14 wherein said second member is integral with said card body.

16. The card of claim 14 wherein said second member comprises a flap cut from said card body.

17. A card for displaying a product having an end, said card comprising a body, said body comprising a substantially planar surface, a member extending from said body surface to a position substantially perpendicular to said body surface, proximate the end of the product, and an elongated fastener extending from said body surface over the product to maintain the product adjacent said body surface.

18. The card of claim 17 wherein said member is integral with said card body.

19. The card of claim 17 wherein said member comprises a flap cut from said card body.

20. The card of claim 17 wherein said card body has an edge and said member extends in a direction substantially parallel to said card edge.

21. The card of claim 17 wherein said card body has an edge and said elongated fastener extends in a direction substantially parallel to said body edge.

22. The card of claim 17 wherein said fastener extends in a direction substantially parallel to said member.

23. The card of claim 17 wherein said body has an edge and both said member and said fastener extend in planes substantially parallel to said edge.

24. The card of claim 17 wherein said body is generally rectangular.

25. The card of claim 17 wherein said body has a width and wherein each of said member and said fastener extend in a direction along the width of said body.

26. The card of claim 17 wherein said fastener comprises a filament.

27. The card of claim 17 wherein said fastener comprises first and second ends, said fastener ends penetrating said surface to anchor said fastener to said card body.

28. The card of claim 27 further comprising an enlarged part attached to each of said fastener ends.

29. The card of claim 17 wherein said fastener comprises a flexible filament with an enlarged part at each end.

30. The card of claim 17 wherein the product has a second end and further comprising a second member extending from said surface in a direction substantially perpendicular to said surface, spaced from said member, and proximate the second end of the product.

31. The card of claim 17 wherein said second member is integral with said body.

32. The card of claim 17 wherein said second member comprises a flap cut from said body.

33. The card of claim 30 wherein the product is situated between said member and said second member.

34. A card for displaying a product with a generally cylindrical portion, having first and second ends, said card comprising a body comprising a substantially planar surface, first and second spaced members, each of said members extending from said surface in a direction substantially perpendicular to said surface with the article extending therebetween, and an elongated fastener extending from said surface over the product to maintain the product adjacent said card surface.

35. The card of claim 34 wherein said fastener comprises a filament.

36. The card of claim 34 wherein said fastener comprises first and second ends, said fastener ends penetrating said surface to anchor said fastener to said card body.

37. The card of claim 36 further comprising an enlarged part attached to each of said fastener ends.

38. The card of claim 34 wherein said fastener comprises a flexible filament with an enlarged part at each end.

39. A method of securing a product with an end to a display card of the type having a body with a substantially planar surface, the method comprising the following steps:
(a) forming a flap member in the body;
(b) rotating the flap member to a position substantially perpendicular to the body surface;
(c) placing the product adjacent the body surface with the end thereof proximate the flap member; and
(d) attaching an elongated fastener to the card body to maintain the product adjacent the body surface.

40. The method of claim 39 wherein the product has a second end and further comprising the steps of:
(e) forming a second flap member in the body at a location remote from the flap member;
(f) rotating the second flap to a position substantially perpendicular to the body surface; and
(g) placing the product adjacent the body surface with the ends thereof between the flap member and the second flap member.

41. The method of claim 39 wherein the fastener includes a flexible filament with an enlarged part at either end.
